(19) United States
(12) Patent Application Publication
(10) Pub. No.: US 2014/0165556 A1
(43) Pub. Date: Jun. 19, 2014

(54) ENGINE INCLUDING A WASTEGATE VALVE AND METHOD FOR OPERATION OF A TURBOCHARGER SYSTEM

(71) Applicant: FORD GLOBAL TECHNOLOGIES, LLC, Dearborn, MI (US)

(72) Inventors: Keith Michael Plagens, Northville, MI (US); Daniel Joseph Styles, Canton, MI (US)

(73) Assignee: FORD GLOBAL TECHNOLOGIES, LLC, Dearborn, MI (US)

(21) Appl. No.: 13/719,107

(22) Filed: Dec. 18, 2012

(51) Int. Cl. F02B 37/18

(52) U.S. Cl. CPC F02B 37/183
USPC 60/602; 123/564

(57) ABSTRACT

A turbocharger system is described herein. The turbocharger system may include a cylinder head forming a portion of a combustion chamber and including an integrated exhaust manifold in fluidic communication with the combustion chamber and a wastegate valve positioned within the cylinder head including an inlet in fluidic communication with the integrated exhaust manifold and an outlet in fluidic communication with an outlet of a turbine positioned downstream of the integrated exhaust manifold.

### FIELD

The present disclosure relates to a turbocharger system including a wastegate valve integrated into a cylinder head.

### BACKGROUND AND SUMMARY

Turbochargers may be used in engines to provide boost for increased engine power output or for enabling engine downsizing. However, it may be desirable to adjust the amount of boost provided to the engine during certain operating conditions. Therefore, turbocharger wastegates positioned in turbine bypasses have been implemented. Wastegates may also increase the temperature of exhaust gas routed to downstream components when compared to exhaust gas routed through the turbine. Consequently, emission control devices such as catalysts positioned downstream of the turbine may reach light-off temperature more quickly.

For example, US 2011/0099998 discloses a turbine having a wastegate and turbine bypass integrated into the housing of the turbine to enable boost adjustment in the engine.

The inventors have recognized several drawbacks with the wastegate disclosed in US 2011/0099998. The turbine housing may impose design constraints on the turbine bypass and wastegate. Consequently, the length of the turbine bypass may be increased, thereby increasing the exhaust gas flow path between the cylinders and downstream emission control devices when turbine operation is not desired and the wastegate is open. This may lead to increased emission during cold starts, for example. Furthermore, to withstand the high temperatures around the turbine, the wastegate and turbine bypass conduit may be constructed from materials that have high thermal resistances. However, such materials may be costly, thereby increasing the cost of the turbocharger and engine.

The inventors herein have recognized at least some of the above issues and developed a turbocharger system. The turbocharger system may include a cylinder head forming a portion of a combustion chamber and including an integrated exhaust manifold in fluidic communication with the combustion chamber and a wastegate valve positioned within the cylinder head including an inlet in fluidic communication with the integrated exhaust manifold and an outlet in fluidic communication with an outlet of a turbine positioned downstream of the integrated exhaust manifold.

When the wastegate valve is positioned in the cylinder head, the length of the turbine bypass conduit (in which the wastegate is positioned) can be reduced, thereby increasing the temperature of the exhaust gases delivered to a downstream emission control device during cold starts. For example, the reduction in bypass conduit length may be achieved through the elimination of the design constraints imposed by the integration of the turbine bypass conduit into the housing of the turbine. As a result, the emission control device may reach light-off temperatures more quickly when compared to a turbocharger system having a wastegate position outside of the cylinder head.

In some examples, the turbocharger system may further include a cylinder head cooling jacket including a coolant passage traversing a housing of the wastegate valve. In this way, the cylinder head cooling circuit serves to not only provide cooling to the cylinder head, but also the wastegate valve, if desired.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure. Additionally, the above issues have been recognized by the inventors herein, and are not admitted to be known.

### BRIEF DESCRIPTION OF THE DRAWINGS

FIG. 1 shows a schematic depiction of an engine including a turbocharger system; and

FIG. 2 shows a method for operation of a turbocharger system.

### DETAILED DESCRIPTION

A turbocharger system having a wastegate valve integrated into a cylinder head is described herein. The integration of the wastegate valve into the cylinder head enables more than a mere reduction in components and/or complexity, but rather provides several synergistic effects that can improve engine performance. For example, such an approach enables the cylinder head, (rather than or in addition to, the turbocharger housing) to serve as a heat sink for the wastegate, thereby decreasing the temperature of the wastegate and decreasing the likelihood of wastegate thermal degradation. This is especially true for an integrated exhaust manifold with coolant passages in the head providing improve heat rejection capabilities. In this way, the wastegate valve may be cooled by the cylinder head cooling circuit when the engine and/or wastegate valve are operating at elevated temperatures, such as above a desired operating temperature. Consequently, the cylinder head cooling circuit may serve to provide multiple effects, thereby decreasing the cost of the engine beyond the mere integration of the wastegate into the cylinder head. Additionally, the length of the turbine bypass conduit in which the wastegate is positioned can be reduced due to the positioning of cylinder head relative to the turbocharger housing, thereby increasing the temperature of the exhaust gases delivered to a downstream emission control device, for example during cold starts when the wastegate is open. As a result, the emission control device may reach light-off temperatures more quickly.

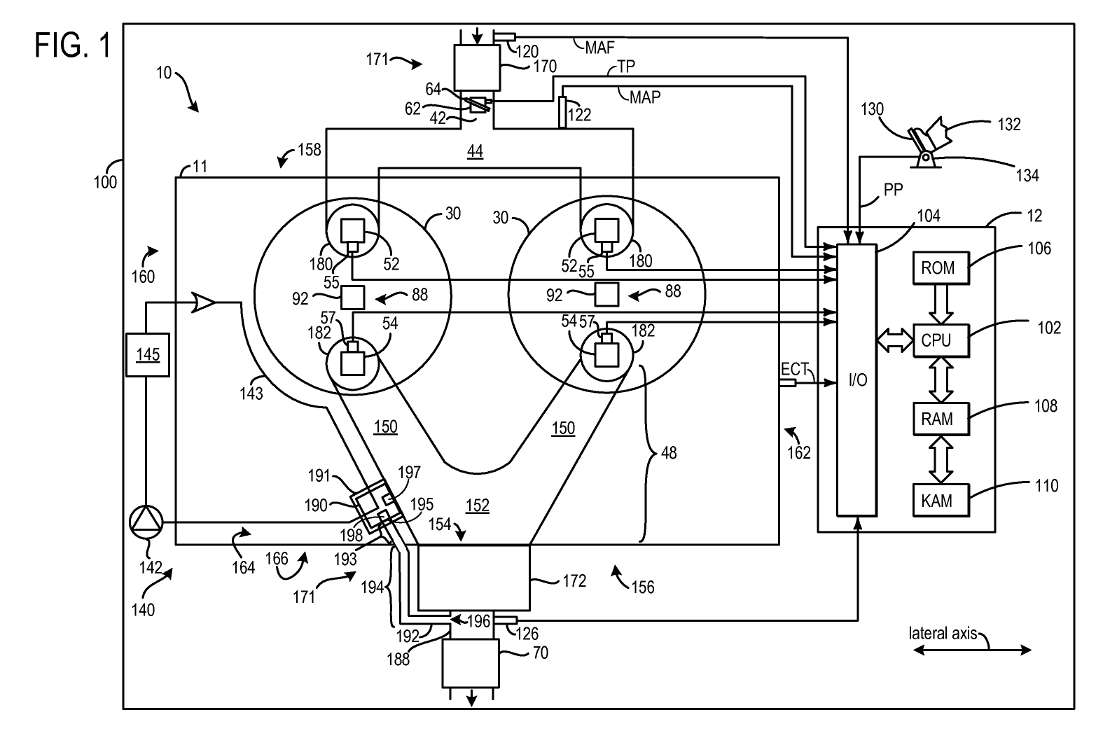

FIG. 1 is a schematic diagram showing a multi-cylinder engine 10 including a cylinder head 11. The cylinder head 11 may be formed out of single continuous piece of material in one example. Specifically, the engine 10 includes two cylinders in an inline configuration. However, it will be appreciated that an alternate number of cylinders and/or cylinder configuration may be used in other examples. For instance, the engine may include 4 cylinders in an inline configuration, 4 cylinders in a V configuration, etc.

The engine 10 which may be included in a propulsion system of a vehicle 100 in which an exhaust gas sensor 126 (e.g., air-fuel sensor) may be utilized to determine an air fuel ratio of exhaust gas produce by engine 10. The air fuel ratio (along with other operating parameters) may be used for feedback control of engine 10 in various modes of operation. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Cylinders (i.e., combustion chamber) 30 of engine 10 may include combustion chamber walls with piston (not shown) positioned therein. The pistons may be coupled to a crankshaft (not shown) so that reciprocating motion of the piston is translated into rotational motion of the crankshaft. Additionally, the crankshaft may be coupled to at least one drive wheel of a vehicle via an intermediate transmission system. Further, a starter motor may be coupled to the crankshaft via a flywheel to enable a starting operation of engine 10.

Cylinder 30 may receive intake air from intake manifold 44 via intake passage 42 and may exhaust combustion gases via an integrated exhaust manifold 48 integrated into the cylinder head 11. The integrated exhaust manifold 48 including a plurality of exhaust runners 150. Specifically, two exhaust runners are shown in FIG. 1. However, it will be appreciated that additional exhaust runners may be included in the exhaust manifold. For example, the engine 10 may include two exhaust valves per cylinder. Therefore, the engine may include four exhaust runners in such an example, a single runner per exhaust valve. The exhaust runners 150 fluidly converge to form a single merged conduit 152 having an outlet 154 on a first side 156 (e.g., exhaust side) of the cylinder head 11. The cylinder head 11 further includes a second side 158 (e.g., an intake side), a third side 160 (e.g., top side), a fourth side 162 (e.g., bottom side), a fifth side 164, and a sixth side 166.

The intake manifold 44 and exhaust manifold 48 can selectively communicate with cylinders 30 via respective intake valves 52 and exhaust valves 54. Thus, each of the cylinders 30 includes a single intake valve and a single exhaust valve in the depicted example. However, in other examples, each of the cylinders may include two or more intake valves and/or two or more exhaust valves. A throttle 62 including a throttle plate 64 is positioned in the intake passage 42. The throttle is configured to adjust the amount of airflow flowing to the cylinders 30.

The throttle 62 is positioned downstream of a compressor 170 included in a turbocharger system 171. The compressor 170 is configured to increase the pressure of the intake air, thereby providing boosted air to the cylinders 30. The turbocharger further includes a turbine 172. The turbine 172 is configured to receive exhaust gas from the integrated exhaust manifold 48. In the depicted example the turbine 172 is directly coupled to the cylinder head 11. Directly coupled indicates that there are no intervening components between the coupled components. Specifically, the turbine 172 is in direct fluidic communication with the outlet 154 of the exhaust manifold 48. Coupling the turbine directly to the cylinder head reduces losses in the exhaust system, thereby increasing the turbocharger's efficiency as well as the boost provided the engine, if desired. However, in other examples, the turbine may be coupled to an exhaust conduit downstream of the cylinder head. The turbine 172 is configured to extract energy from the exhaust gas flow and convert it into rotational energy. The rotational energy in the turbine 172 is transferred to the compressor 170 via mechanical linkage such as a drive shaft. In this way, energy from the exhaust gas may be extracted to provide boost to the engine. As a result, the combustion efficiency and/or engine power output may be increased.

The turbocharger system 171 further includes a wastegate valve 190. The wastegate valve 190 is integrated into the cylinder head 11. The integration of the wastegate valve 190 into the cylinder head 11 enables the temperature of the exhaust gases delivered to the emission control device 70 to be increased when compared to wastegates positioned external to the cylinder head via a decrease in a length of a turbine bypass conduit in which the wastegate valve is positioned. Increasing the exhaust gas temperatures delivered to the emission control device may be beneficial during a cold start, when the emission control device is below a light-off temperature. As a result, engine emissions may be decreased when the wastegate valve is integrated into the cylinder head. Integration of the wastegate into the cylinder head 11 also enables an engine cooling system to serve multiple aspects, cooling the cylinder head as well as cooling the wastegate valve, during desired time intervals. For example, the wastegate valve may be cooled when the cylinder head and/or wastegate valve is above a desired operating temperature. In this way, the likelihood of thermal degradation of the wastegate valve is decreased. Additionally, the cost of the engine may be reduced when the engine cooling system serves a dual use.

The wastegate valve 190 includes a wastegate valve inlet 197 and a wastegate valve outlet 198. The wastegate valve inlet 197 is in fluidic communication with integrated exhaust manifold 48 and the wastegate valve outlet 198 is in fluidic communication with an exhaust conduit 188 positioned downstream (e.g., directly downstream) of the turbine 172. In some examples, the outlet 198 may be in direct fluidic communication with an outlet of the turbine 172. In the depicted example, the inlet 197 is in direct fluidic communication with the integrated exhaust manifold. However, in other examples, the wastegate valve 190 may be positioned in a downstream portion of a turbine bypass conduit 192 traversing the cylinder head 11.

Integrating the wastegate valve 190 into the cylinder head 11 also enables a number of different types of wastegate valves to be used in the turbocharger system. The wastegate valve 190 may be a poppet valve in one example. However in another example the wastegate valve 190 may be a spool valve. The spool valve may include cylindrical spools that may be configured to block and open channels in fluidic communication (e.g., direct fluidic communication) with a turbine bypass conduit 192, discussed in greater detail herein.

However, in another example, the wastegate valve 190 may be a butterfly valve. The butterfly valve may include a plate (e.g., disk) that is actuatable to inhibit and permit exhaust gas flow through the turbine bypass conduit 192. The plate may be sized to substantially inhibit exhaust gas flow in a closed configuration. Therefore, the peripheral contours of the plate may follow the contours of the turbine bypass conduit. In an open configuration the plate may be rotated to permit exhaust gas flow through the turbine bypass conduit.

The wastegate valve 190 may be a sluice gate valve in another example. The sluice gate valve may include a gate configured to move into and out of the path of the exhaust gas. Specifically in one example, the gate may be moved in a direction that is perpendicular to the central axis of the turbine bypass conduit during actuation. The sealing surfaces between the gate and seats in the valve may be planar, in some examples.

The wastegate valve 190 may be a barrel valve in another example.

The wastegate valve 190 may be a flapper valve in another example. The flapper valve may include a cover plate that seats and seals on a flange of the turbine bypass conduit. The cover plate may pivot via mechanical linkage to open and close the valve. Thus, in an open configuration the cover plate may be pivoted such that it is spaced away from the flange and in a closed configuration the cover plate may be seated and sealed on the flange.

In one example, the wastegate valve 190 is positioned in a wastegate port 191 extending into the cylinder head 11 from an eternal surface. In this way, the wastegate valve 190 may be accessible for installation, removal, and/or repair. Specifically, the wastegate port 191 may extend from a top side of the cylinder head 11. As shown, the wastegate valve 190 is coupled to a lateral side of the integrated exhaust manifold 48. A lateral axis is provided for reference. However, in other examples the wastegate valve 190 may be positioned vertically above the integrated exhaust manifold 48 and coupled to a top side of the integrated exhaust manifold. It will be appreciated that the vertical axis may extend into and out of the page. Positioning the wastegate valve 190 in this way may position the wastegate valve 190 closer to the turbine 172.

The turbocharger system 171 further includes a turbine bypass conduit 192. The turbine bypass conduit 192 includes a first portion 193 traversing the cylinder head 11 and a second portion 194 external to the cylinder head 11. However, in other examples the entire turbine bypass conduit 192 may be positioned external to the cylinder head 11. Additionally, the turbine bypass conduit 192 includes an inlet 195 in fluidic communication with the integrated exhaust manifold 48 and an outlet 196 in fluidic communication (e.g., direct fluidic communication) with the exhaust conduit 188. In this way, exhaust gas may bypass the turbine 172. The inlet 195 is shown in direct fluidic communication with the wastegate valve outlet 198. However, in other examples, the inlet 195 may open into the integrated exhaust manifold 48 and the wastegate valve 190 may be coupled to the turbine bypass conduit 192 at a location between the inlet 195 and the outlet 196.

The engine 10 further includes a cylinder head cooling circuit 140. The cylinder head cooling circuit 140 may be included in an engine cooling system. The engine cooling system may further include coolant passages traversing a cylinder block coupled to the cylinder head, in one example. The cylinder head cooling circuit 140 includes a coolant pump 142 configured flow fluid around passages in the circuit. The cylinder head cooling circuit 140 includes at least one coolant passage 143 traversing the cylinder head 11. It will be appreciated that the cylinder head cooling circuit 140 may include a plurality of coolant passages traversing the cylinder head in other examples. As shown, a portion 144 of the coolant passage 143 traverses the wastegate valve 190. In one example, the coolant passage may traverse a housing of the wastegate valve 190. However, in other examples, the coolant passage may be coupled to the housing of the wastegate valve or traverse a portion of the cylinder head adjacent to the wastegate valve. In this way, the engine cooling system, and specifically the cylinder head cooling circuit, serves a dual use by providing cooling to the cylinder head as well as the wastegate valve. Consequently, the cost of the engine may be reduced when compared to an engine which may use separate cooling circuits to cool the cylinder head and wastegate valve.

The cylinder head cooling circuit 140 further includes a heat exchanger 145 configured to remove heat from the cylinder head cooling circuit 140. The heat exchanger 145 is positioned outside of the cylinder head 11 in the depicted example. It will be appreciated that the cylinder head 11 may act as a heat sink for the wastegate valve 190 due to its large thermal mass, thereby providing cooling to the wastegate valve 190, reducing the likelihood of thermal degradation to the wastegate valve. Additionally, it will be appreciated that the wastegate may be constructed out of a less thermally resistant material when it is operated at a lower temperature, if desired. Consequently, the cost of the wastegate may be reduced when compared to a wastegate constructed out of material having greater thermal resistance, which may be more costly.

The intake valves 52 and the exhaust valves 54 may be positioned in intake ports 180 and exhaust ports 182. The intake ports 180 and the exhaust ports 182 are in fluidic communication (e.g., direct fluidic communication) with their respective cylinder 30. The intake valves 52 may inhibit and permit intake airflow from the intake manifold 44 to its respective cylinder 30 and the exhaust valves 54 may inhibit and permit exhaust gas from their respective cylinder 30 to the exhaust manifold 48.

The intake valves 52 and/or exhaust valves 54 may be actuated by cams in one example. However, in other examples electric cam actuation may be used. When cams are use to actuate the valves the engine 10 may include a variable cam timing system configured to adjust (advance or retard) cam timing, in one example. The position of intake valves 52 and exhaust valves 54 may be determined by position sensors 55 and 57, respectively.

The engine 10 may further include a fuel delivery system (not shown) configured to supply the cylinders 30 with fuel at desired time intervals. The controller 12 may be configured to control the amount of fuel provided to the cylinders and the timing of the fuel provided to the cylinders. Port and/or direct injection system may be used to supply the fuel to the cylinders.

Ignition system 88 can provide an ignition spark to cylinders 30 via ignition devices 92 (e.g., spark plugs) in response to spark advance signal SA from controller 12, under select operating modes. Though spark ignition components are shown, in some examples, cylinders 30 or one or more other combustion chambers of engine 10 may be operated in a compression ignition mode, with or without an ignition spark.

Exhaust gas sensor 126 is shown coupled to exhaust passage 48 of exhaust system 50 upstream of emission control device 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor. In some examples, exhaust gas sensor 126 may be a first one of a plurality of exhaust gas sensors positioned in the exhaust system. For example, additional exhaust gas sensors may be positioned downstream of emission control device 70.

Emission control device 70 is shown arranged along exhaust passage 48 downstream of exhaust gas sensor 126. Emission control device 70 may be a three way catalyst (TWC), NOx trap, various other emission control devices, or combinations thereof. In some examples, emission control device 70 may be a first one of a plurality of emission control devices positioned in the exhaust system. In some examples, during operation of engine 10, emission control device 70 may be periodically reset by operating at least one cylinder of the engine within a particular air/fuel ratio.

Controller 12 is shown in FIG. 1 as a microcomputer, including microprocessor unit 102, input/output ports 104, an electronic storage medium for executable programs and calibration values shown as read only memory 106 (e.g., memory chip) in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to the cylinder head 11; throttle position (TP) from a throttle position sensor; and absolute manifold pressure signal, MAP, from sensor 122. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor can give an indication of engine torque. Further, this sensor, along with the detected engine speed, can provide an estimate of charge (including air) inducted into the cylinder. An engine speed sensor may also be coupled to the crankshaft and electronically coupled to the controller 12 to provide the controller with an engine speed signal.

During operation, each of the cylinders 30 in the engine 10 may undergo a four stroke cycle: the cycle includes the intake stroke, compression stroke, expansion stroke, and exhaust stroke. It will be appreciated that the combustion cycles in the different cylinders may not be implemented simultaneously, if desired. Specifically, combustion in the cylinders may be staggered to reduce engine vibration in some examples. However, other types of combustion cycles have been contemplated.

During the intake stroke, generally, the exhaust valve closes and the intake valve opens. Air is introduced into cylinder via the intake manifold, for example, and the piston moves to the bottom of the combustion chamber so as to increase the volume within the cylinder. The position at which the piston is near the bottom of the combustion chamber and at the end of its stroke (e.g. when the cylinder is at its largest volume) is typically referred to by those of skill in the art as bottom dead center (BDC). During the compression stroke, the intake valve and the exhaust valve are closed. The piston moves toward the cylinder head so as to compress the air within the. The point at which the piston is at the end of its stroke and closest to the cylinder head (e.g. when the cylinder is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition devices such as a spark plug, resulting in combustion. Additionally or alternatively compression may be used to ignite the air/fuel mixture. During the expansion stroke, the expanding gases push the piston back to BDC. A crankshaft may convert piston movement into a rotational torque of the rotary shaft. Finally, during the exhaust stroke, the exhaust valve opens to release the combusted air-fuel mixture to an exhaust manifold and the piston returns to TDC. Note that the above is described merely as an example, and that intake and exhaust valve opening and/or closing timings may vary, such as to provide positive or negative valve overlap, late intake valve closing, or various other examples. Additionally or alternatively compression ignition may be implemented in the cylinder.

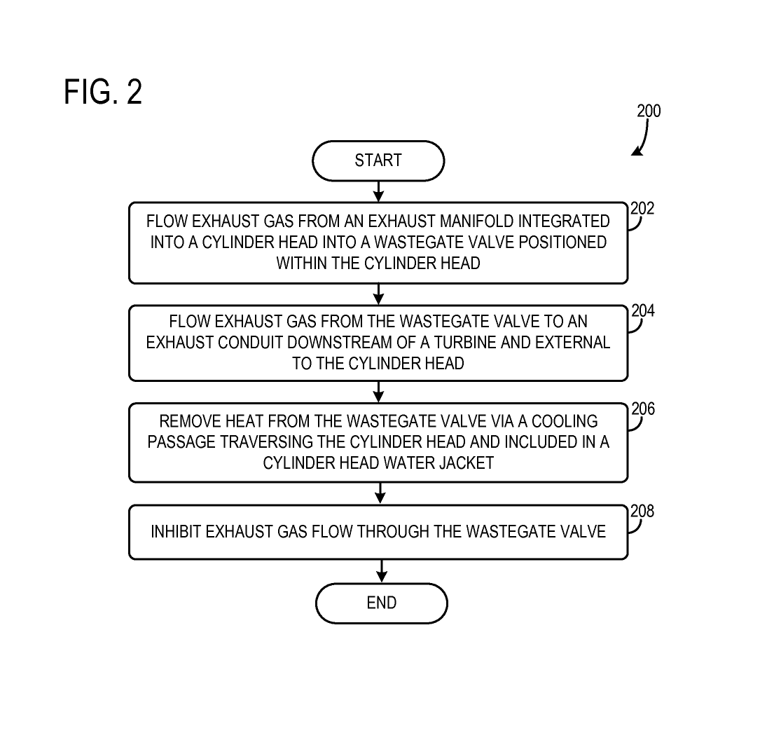

FIG. 2 shows a method 200 for operating a turbocharger system. The method 200 may be implemented by the turbocharger system and components described above with regard to FIG. 1 or may be implemented by other suitable turbocharger systems and components.

At 202 the method includes flowing exhaust gas from an exhaust manifold integrated into a cylinder head into a wastegate valve positioned within the cylinder head. Next at 204 the method includes flowing exhaust gas from the wastegate valve to an exhaust conduit downstream of a turbine and external to the cylinder head. In some examples, flowing exhaust gas from the wastegate valve to the exhaust conduit may be implemented when an emission control device positioned downstream of the exhaust conduit is below a threshold light-off temperature.

Next at 206 the method includes removing heat from the wastegate valve via a cooling passage traversing the cylinder head and included in a cylinder head water jacket. As previously discussed, the cooling passage may be adjacent to or traverses a wastegate valve housing. At 208 the method includes inhibiting exhaust gas flow through the wastegate valve.

Note that the example routines included herein can be used with various engine and/or vehicle system configurations. Further, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A turbocharger system comprising:
a cylinder head forming a portion of a combustion chamber and including an integrated exhaust manifold in fluidic communication with the combustion chamber; and
a wastegate valve positioned within the cylinder head including an inlet in fluidic communication with the integrated exhaust manifold and an outlet in fluidic communication with an outlet of a turbine positioned downstream of the integrated exhaust manifold.

2. The turbocharger system of claim 1, where the wastegate valve is a spool valve.

3. The turbocharger system of claim 1, where the wastegate valve is a butterfly valve.

4. The turbocharger system of claim 1, where the wastegate valve is a sluice gate valve.

5. The turbocharger system of claim 1, where the wastegate valve is a barrel valve.

6. The turbocharger system of claim 1, where the wastegate valve is a flapper valve.

7. The turbocharger system of claim 1, where the cylinder head is formed of a continuous piece of material.

8. The turbocharger system of claim 1, further comprising a turbine bypass conduit in fluidic communication with the wastegate valve outlet and an exhaust conduit positioned downstream of the turbine, where the turbine bypass conduit includes a first portion traversing the cylinder head and a second portion external to the cylinder head.

9. The turbocharger system of claim 1, where the integrated exhaust manifold includes a plurality of exhaust runners fluidly converging to form a single merged conduit having an outlet on a side of the cylinder head.

10. The turbocharger system of claim 1, where the turbine is in direct fluidic communication with an outlet of the integrated exhaust manifold.

11. The turbocharger system of claim 1, where the wastegate valve is positioned in a wastegate port extending into the cylinder head from an external surface.

12. The turbocharger system of claim 1, further comprising a cylinder head cooling jacket including a coolant passage traversing a housing of the wastegate valve.

13. A method for operating a turbocharger system, comprising:
flowing exhaust gas from an exhaust manifold integrated into a cylinder head into a wastegate valve positioned within the cylinder head; and
flowing exhaust gas from the wastegate valve to an exhaust conduit downstream of a turbine and external to the cylinder head.

14. The method of claim 13, further comprising removing heat from the wastegate valve via a cooling passage traversing the cylinder head and included in a cylinder head water jacket.

15. The method of claim 14, where the cooling passage is adjacent to or traverses a wastegate valve housing.

16. The method of claim 13, further comprising inhibiting exhaust gas flow through the wastegate valve.

17. The method of claim 13, where flowing the exhaust gas from the wastegate valve to the exhaust conduit is implemented when an emission control device positioned downstream of the exhaust conduit is below a threshold light-off temperature.

18. A wastegate valve comprising:
an inlet opening into an integrated exhaust manifold integrated into a cylinder head; and
an outlet in direct fluidic communication with a turbine bypass conduit including a first portion traversing the cylinder head and a second portion external to the cylinder head and in fluidic communication with an exhaust conduit positioned downstream of a turbine positioned downstream of the integrated exhaust manifold.

19. The wastegate valve of claim 18, where the wastegate is positioned adjacent to an outlet flange of the cylinder head.

20. The wastegate valve of claim 18, where the wastegate valve is positioned vertically above the integrated exhaust manifold.
